(19) United States
(12) Patent Application Publication
(10) Pub. No.: US 2007/0281272 A1
(43) Pub. Date: Dec. 6, 2007

(54) Decorative Cover For A Dental Handpiece

(76) Inventor: Maryam Rahbari, Sanford, FL (US)

Correspondence Address: James H. Beusse, Esquire;Beusse Wolter Sanks Mora & Maire, P.A., Suite 2500, 390 North Orange Avenue, Orlando, FL, 32801, US

(21) Appl. No.: 11/755,337

(22) Filed: May 30, 2007

Related U.S. Application Data
(60) Provisional application No. 60/803,540, filed on May 31, 2006.

(51) Int. Cl. A61C 3/00

(52) U.S. Cl. 433/114; 433/141

(57) ABSTRACT

A decorative cover for the handle of a dental instrument of the type having a shank and a tip for carrying a drilling or grinding tool. The cover includes a tubular casing of synthetic resin and having an inner configuration adapted to conform to the handle of the tool. The cover has an outer configuration in the form of a character familiar to a child. The cover is fitted onto the handle of the dental instrument and conceals the shank from a child undergoing dental treatment.

This application claims the benefit of U.S. provisional application No. 60/803,540 filed May 31, 2006.

The present invention relates to a decorative cover for the handle of a dental instrument comprising a shank having a tip for carrying a tooth treating tool, such as a drill, a turbine carrying a drill or the like. The decorative cover is disposable and may be discarded after each use.

### SUMMARY OF THE INVENTION

Children are generally wary of dental procedures and afraid of the various instruments used by dentists, particularly the instruments used in drilling or grinding of teeth. Much of this fear is related to the overall sterile appearance of dental instruments. The present invention proposes to alleviate at least some of this fear by concealing the instruments such as the dental drill within a decorative cover that is familiar to a child. For example, the cover may be formed with an outer appearance of a cartoon character or other character such as an angel or fairy. The cover is adapted to fit about the shank of a dental drilling or grinding tool so as to hide a large portion of the tool from the view of the child.

While the cover of the present invention is particularly adapted to conceal a dental tool from the view of a child, the cover may also be used to as a sterile cover for the tool shank to minimize transmission of infectious material from one patient to another.

The above and other objects and advantages are accomplished according to the invention with a decorative cover that may be sterile for the handle of a dental tool comprising a tool shank having a tip for carrying a tooth treating tool, the cover comprising a molded housing of synthetic resin and having an internal configuration adapted to conform to the tool shank. The cover, when installed on the tool shank, encompasses the shank such that a drill bit or grinding attachment protrudes from an end of the cover, such as from the top of the head of the character represented by the cover configuration. In a preferred form, the cover is formed in two segments comprising a front and a back of the character and is adapted to be snap fit about the shank of the dental instrument. The internal configuration of the cover is designed to fit snugly about the instrument shank so that the cover does not slip during use of the instrument by the dentist. The cover is further adapted to be removed by merely pulling the two segments apart. The segments may then be reconnected to form the character and given to the child to take home or may be sterilized using conventional techniques for use with another dental procedure.

### BRIEF DESCRIPTION OF THE DRAWINGS

FIG. 1 is a side view of a dental instrument juxtaposed with one form of the inventive cover; and

FIG. 2 is another view of the instrument and cover of FIG. 1 taken from a rear angle; and

FIG. 3 is a partial frontal view of the cover of FIG. 1.

### DETAILED DESCRIPTION OF THE INVENTION

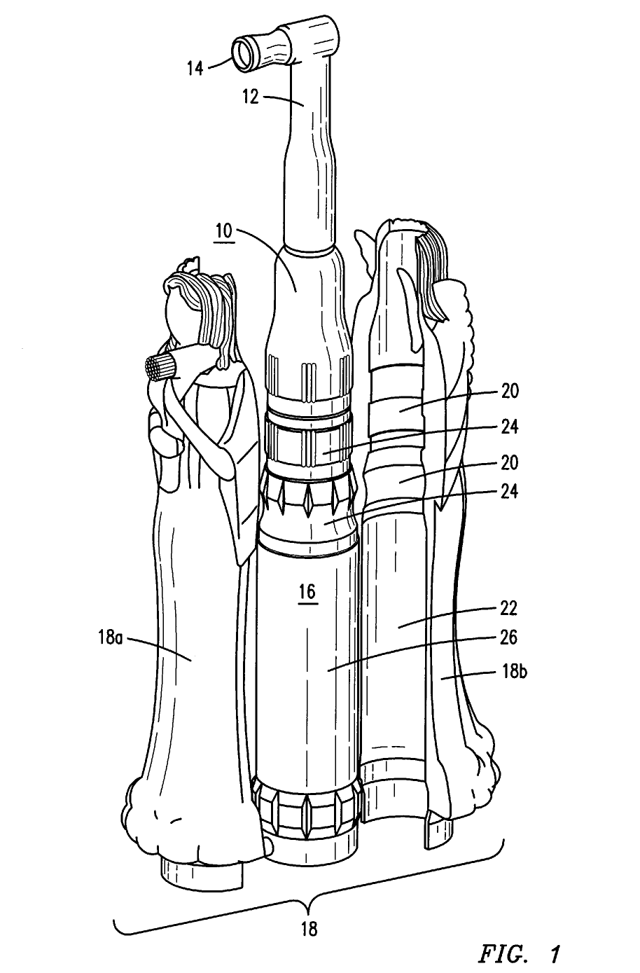

As clearly shown in the drawing, each dental instrument comprises a shank having a tip for carrying a tooth treating tool. Dental instrument 10 shown in FIG. 1 is designed to carry a tooth treating turbine 12 carrying a polishing cup 14. The shank 16, sometimes referred to as a handle, comprises that portion of the instrument that includes a motor for driving the turbine. The motor may be electric, hydraulic or pneumatic. It will also be appreciated that the shank 16 may have other shapes or configurations slightly different from that shown. The conforming cover 18, comprising the front and back portions 18a and 18b, is preferably a molded plastic character that may be comforting to a child undergoing a dental procedure. In the illustrative embodiment, the character represented by cover 18 is an angel. However, it is contemplated that many other character representations could be used. For example, the character could be an animal or a cartoon character. In general, it is anticipated that a dental office would have a selection of different characters that could be used to conceal the shank of the instrument so as to minimize the fear of the dental procedure. Further, it is expected that the character could be removed from the instrument and given to the child to take home at the end of the procedure. The inner surface of the cover portions 18a and 18b are each shaped or configured to fit about the shank 16. One or both portions may be constructed with conventional snap fittings such as are used in commercially available snap together plastic models of automobiles and airplanes. The techniques for creating snap together models is a matter of routine for plastic model manufacturers and is not considered part of nor necessary to show in the drawing figures. By way of example, the mating cover halves may utilize protrusions extending from one cover half and arranged to be inserted into mating recesses in the other cover half. Typically, the protrusions have a ball shaped end that snap into a mating and expandable recess.

It is important that the inner surface of the cover 18 be shaped to fit about the shank 16 snugly since the person using the instrument will be holding and manipulating the instrument through contact with the cover. While it is possible to mold the inside of the covers 18a and 18b to conform to the outer shape of the shank 16 and thereby create a tight fit between the cover and shank, it may be desirable to mold the cover from a soft or deformable rubber, i.e., an elastomeric material, that can be compressed into snug engagement with the shank 16. Alternatively, the inside surface of the cover 18 may be covered by an elastomeric insert that acts as a buffer between the shank and cover to provide the snug fit.

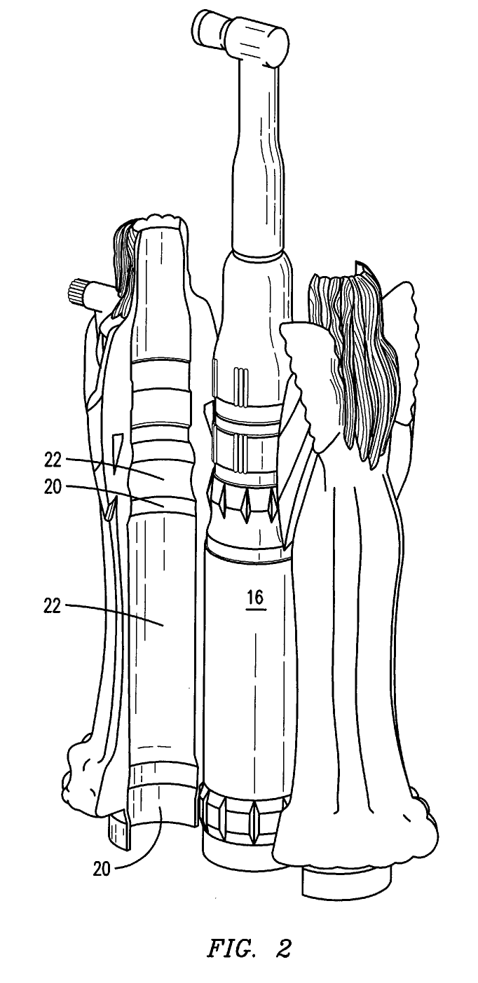

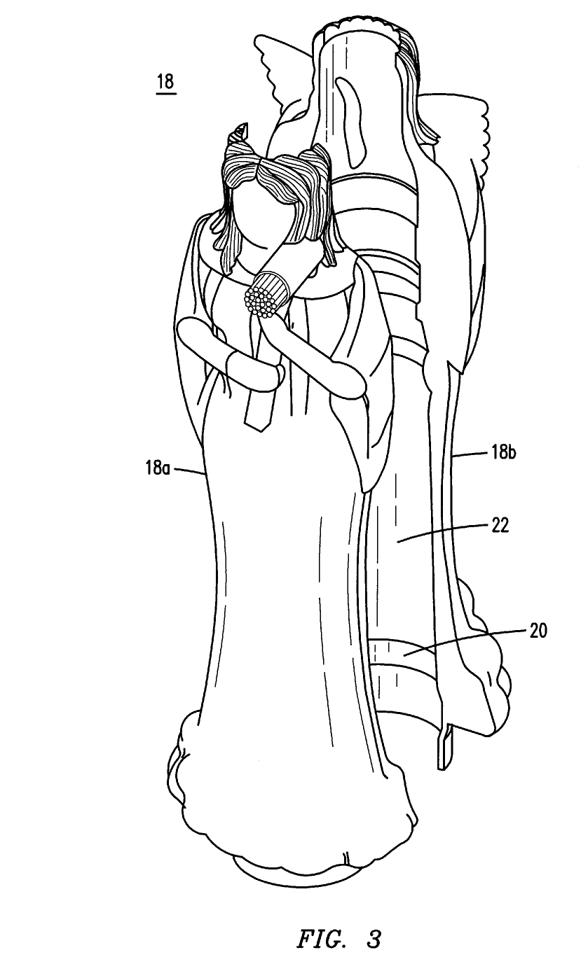

FIG. 3 is a partial front view of the character shown in FIG. 1. Considering FIGS. 1, 2 and 3 together, it can seen that the inner surface of the cover 18 is shaped to fit about the shank 16. In that regard, the cover's inner surface is provided with grooves 20 and lands 22 that correspond to mating surfaces 24 and 26 on shank 16. It will be appreciated that if a relatively stiff material is used for the cover, in order to establish the snug fit between the cover and shank, then it will be necessary to create a different inner surface configuration to match different shank designs. In dental drills for example, the shank is often just a tapered or cylindrical configuration and may be of different diameters. Accordingly, the production of suitable characters for covering different types and manufacturers of dental instruments may require a plurality of different molds if the characters are molded using conventional molding processes such as plastic injection molding. If the characters are molded with an outer appearance but a generic inner surface that can be subsequently filled or covered with a soft, deformable elastomeric material, fewer molds may be required but additional manufacturing steps are needed to add the inner material. While the primary function of the covers 18 is to alleviate the normal fear that a child may have to the sterile instruments used in dental procedures, it is also recognized that the covers may have a secondary function as a sterile cover for such instruments. The plastic covers 18 may be sterilize at manufacture and provided to the dentist in a sterile package. Since the cover 18 provides an interface between a patient and the shank of the dental instrument, the cover may minimize the need to sterilize the instrument between patients, i.e., if the covers are delivered in sterile packs, a previously sterilized dental instrument may be readily re-used simply by stripping a used cover from the instrument and applying a new one between patients, it being recognized that the functional device attached to the tool shank such as device 12 may be disposable or would need to be sterilized prior to re-use. If disposable, the tubular covers are inexpensive and no renewed sterilization or disinfection of the instrument is required before the next patient can be treated with the instrument using another cover. This enables the dentist to keep a much smaller store of such instruments. The covers may also be constructed of material that can be sterilized to thus allow re-use of the covers for another patient or another procedure.

While the invention has been described in what is considered to be a preferred embodiment, it is intended that the invention not be limited to this embodiment but be interpreted within the full spirit and scope of the appended claims.

What is claimed is:

1. A decorative cover for the handle of a dental instrument comprising a shank having a tip for carrying a tooth treating tool which, in turn, has a tool shank comprising:
a cover comprising a tubular casing of synthetic resin and having an inner configuration adapted to conform to the shank of said instrument, said cover having an outer configuration in the form of a character familiar to a child; and
means operatively associated with said cover to allow said cover to be fitted onto the shank of the dental instrument and conceal the shank from a child undergoing dental treatment.

2. The decorative cover of claim 1 wherein the cover is delivered as a pre-packaged sterile device.

3. The decorative cover of claim 2 wherein the cover is provided with an internal elastomeric liner to enable compressive engagement with the tool shank.

4. The decorative cover of claim 3 wherein the cover is divided into mating halves, each half including mating attachment elements for attaching the halves together about the tool shank.

5. The decorative cover of claim 1 wherein the cover comprises an elastomeric material.
